(19) United States
(12) Patent Application Publication
(10) Pub. No.: US 2002/0112041 A1
(43) Pub. Date: Aug. 15, 2002

(54) Method and system for servicing a wireless data collection device

(76) Inventors: Brian Viscount, Kings Park, NY (US); Mauro Premutico, Brooklyn, NY (US)

Correspondence Address: Ira J. Schaefer, Clifford Chance Rogers & Wells LLP, 200 Park Ave., New York, NY, 10166, US

(21) Appl. No.: 09/780,742

(22) Filed: Feb. 9, 2001

(51) Int. Cl. G06F 15/173

(52) U.S. Cl. 709/223

(57) ABSTRACT

A method for servicing, reconfiguring and/or updating a wireless data collection device, wherein a diagnostic program is provided in the wireless data collection device for diagnosing the operation of the device. A request to service, reconfigure and/or update is received and the diagnostic program is remotely initiated using a TCP/IP communications protocol over a network. Outputs from the diagnostic program are communicated to the network using the TCP/IP communications protocol and servicing, reconfiguring and/or updating information is provided to a user of the device based upon the outputs from the diagnostic program.

### BACKGROUND OF THE INVENTION

The present invention relates to a method and system for servicing wireless automatic data collection devices.

Wireless data collection devices, such as scanning terminals, or integrated scan terminals, such as Symbol Technologies, Inc.'s SPT1500 and SPT1700, collect data such as by scanning barcode symbols. From time to time, devices such as these require service, support and/or reconfiguration. The SPT1500 has a diagnostic program stored therein which can be run by a user to diagnose the operation of the scanner and the terminal itself. However, there are times that require a skilled service representative to review the results of the diagnostic program to determine if and what a malfunction of the terminal may be, or to reconfigure the device for a specific application or use.

One object of the present invention is to provide a method and system for servicing wireless data collection devices.

### SUMMARY OF THE INVENTION

These and other objects and advantages of the present invention are achieved in accordance with the present invention by providing a diagnostic program in a wireless data collection device for diagnosing the operation of the device. A request to service, reconfigure and/or update the device is received and a service representative remotely initiates the diagnostic program on the wireless data collection device by using a standard communications protocol over a network such as the common TCP/IP protocol. The outputs from the diagnostic program are communicated to the service representative over the network using the standard communications protocol and servicing/configuration information is provided to the user of the device from the service representative based upon the outputs from the diagnostic program.

Preferably, the network is the Internet, although an intranet or other form of wireless network may be utilized. In another preferred embodiment, the information is provided over the network from the data collection device to the service representative. In another advantageous embodiment of the present invention, the request to service, reconfigure and/or update the device is received over the network.

The device used herein is preferably an automatic data collection (ADC) terminal, such as a scanning terminal or an RFID reading terminal, and, in particular, it is preferably an ADC terminal. An ADC terminal of the type for use herein is, for example, the Symbol SPT1500 fitted with a wireless modem or other data communication device, Symbol SPT1700 or Symbol SPT2700. Alternatively, the Handspring Visor with the Symbol CSM-150 scanning module and a wireless capability can be used. Additionally, the device can be a cell phone with a built-in scanner.

These and other features of the present invention will become more apparent from the detailed description of the present invention taken with the attached drawings, wherein:

### BRIEF DESCRIPTION OF THE DRAWINGS

FIG. 1 is a schematic of the system for carrying out the method according to the present invention; and

FIG. 2 shows the components of the data collection device in accordance with the present invention.

### DETAILED DESCRIPTION OF THE INVENTION

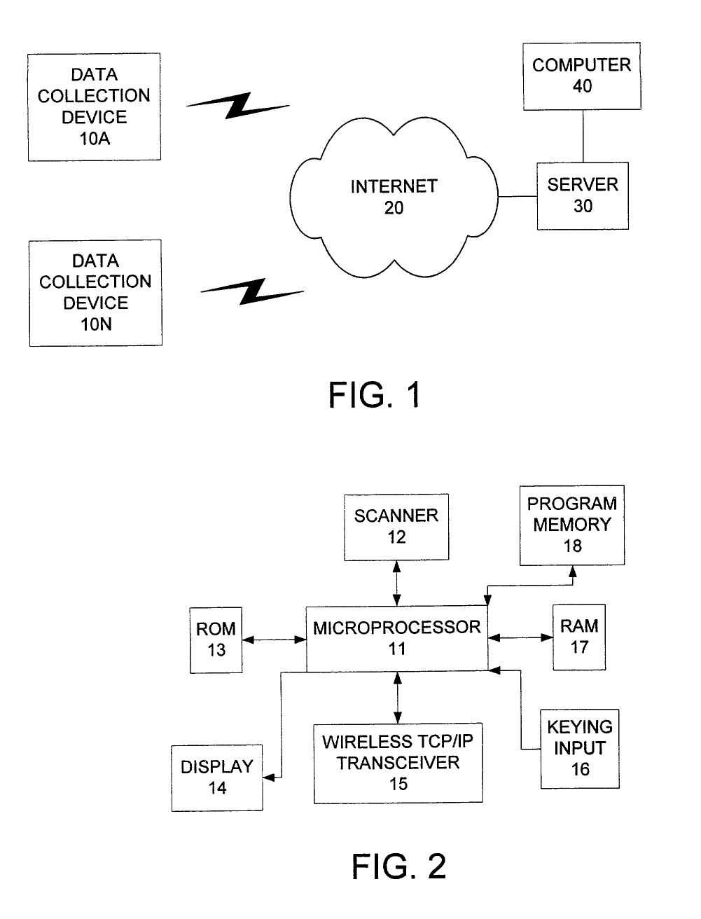

FIG. 1 shows the system according to the invention for carrying out the method of the present invention. A plurality of data collection devices 10A-10N communicate wirelessly with a network, preferably Internet 20, using a TCP/IP communications protocol. The users of the data collection devices are able to communicate with a service representative operating a computer 40 via a server 30. The server 30 works with client software in devices 10A-10N which allows the server 30 to initiate software programs resident in the devices 10A-10N.

The server 30 is connected to a computer 40, either disposed at the same location as the server, or at a location remote thereto. Moreover, while the computer 40 is shown as being separate from the server 30, they can be implemented on the same device. Furthermore, while computer 40 is shown as being connected via a wire connection to the server 30, the two can be connected in a wireless connection or via a network, for example, Internet 20.

Each of the data collection devices have the configuration shown in FIG. 2 in a preferred embodiment. The devices include a microprocessor 11 which interacts with a ROM 13 and RAM 17, as well as a program storage memory 18. The terminal preferably has a keying input 16, which can be a touchpad or mechanically actuated keys, a display 14, which can be an LCD, LED or other type of computer display, and a wireless TCP/IP transceiver 15.

In the preferred embodiment shown in FIG. 2, the ADC collection device collects data via a barcode scanner 12. The scanner is preferably a laser scanner, wand, an imager or other conventional type of scanner. Data is collected via the scanner from a barcode or other graphical code and the data from that code is processed by the microprocessor which decodes it for transmittal via the transceiver 15 to the network 20.

It is understood that the ADC device can have other types of data collection apparatus instead of the scanner 12 or in addition thereto. For example, a magnetic stripe reader, OCR reader, RFID reader, and Biometric data collector.

The diagnostic software is preferably stored in the program memory 18, but can also be stored into ROM 13. Likewise, the client server software can be stored in either the program memory 18 or the ROM 13. While RAM 17 is shown as being separate from the program memory 18, it is understood that the two can be combined into a single storage unit.

In accordance with the invention, if someone seeks to have service on their data collection device, they can send a request to a service representative. This request can take place via a telephone call from the user of the data collection device to the service representative or it can be a message sent via the data collection device over the Internet 20 and through the server 30 to the service representative at computer 40. The service representative at computer 40 then takes remote control over the data collection device 10A via the Internet 20 to initiate a diagnostic program in the wireless communication device. An example of such a diagnostic program is the program Symbol Diagnostics used in the Symbol SPT1500 data collection device.

The diagnostic program produces results which are sent to the client server software and which are then communicated via the transceiver 15 over the Internet through the server 30 to the computer 40. The service representative can then either review the results or software on the computer 40 and can analyze the data received and determine a proposed service protocol. This protocol for other servicing information is then provided to the user of the user of the device. The information can be provided over the telephone from the service representative to the user, or it can be communicated via the server 30, over the Internet 20 and wirelessly to the collection device.

Alternatively, the remote servicing agent can review the client's settings and/or data diagnostics to determine whether any software and/or reconfiguration of the system is required. For example, in the event a scanner is not properly recognizing a data form, the servicing agent may review the barcode types selected for decoding and modify the selection for proper decoding of a designated dataform.

In an alternative embodiment, the computer 40 can be provided with a voice over IP type function and/or imaging capability such that operation of the computer 40 can talk to a service technician, and send visual information to the technician. This can also be implemented in a cell phone having an Internet browser capable of communicating using WAP protocols and viewing HDML pages and a bar code scanning engine or module.

Such capabilities could be invaluable for service technicians who desire to provide real time trouble shooting and/or servicing capabilities. Such real time servicing would avoid return of devices to customer service technicians, device service depots, etc. In the event of a malfunction, the computer operator would simply select the real time service option, hand control of the system to the remote technician who could selectively operate the system to undertake the aforementioned service and diagnostic steps. This type of review would fully correct the service malfunction or be utilized to identify the specific hardware elements which are malfunctioning. This would decrease the down time for service repair in that the service technician would either deliver a new component to the operator, or have the operator deliver the unit to a repair facility which will have the necessary parts and instructions in place to expedite service repair time.

Although the system is described in terms of a server which manages or controls the service routine, the technician could undertake the service and diagnostic repair services from another remote device. The service function software would be loaded onto the remote device and communicated to the computer 40 in need of service or repair. The devices could communicate using standard protocols, whether wide area or local area networks.

The system described above includes a preferred embodiment with at least two software elements: a local client and a remote service application. The system may also include middle ware which would be managed by a control server and used to track service requests, customer identification, identification of remote servicing agents, billing and training review and recording, forwarding of service requests and service technician/supervisor escalation functions. Thus, an intermediate data review function would permit an intermediate supervisor to review the activities of technicians, identify epidemic problems, categorize service level needed, and respond to escalated service requests.

With respect to the client software which could initiate the initial service request, the software, or certain critical applications, could be provided with a local information and application firewall wherein the operator could selectively provide access to the various diagnostic functions of the computer and preclude viewing of critical data such as pricing and/or customer lists. The operator would request a service request and only enable a specific application to be shared or a series of applications. All other activities on the computer would not be delivered to the service center or server.

Ideally, the service technicians view the same screen and/or data as is viewed by the operator. This would provide comfort to the operator that only authorized data is being accessed and potentially provide some training on future service requests.

The remote service application which runs on the service technician's device receives data from the requesting client and displays the data as illustrated on the client computer. In a preferred embodiment, the technician has control over the function of the client such that the keys on the technician's device control the operation of the operator's computer. Thus, in a preferred embodiment a request for service delivered to a technician would also deliver data relating to the requesting device's key configurations, application configuration and hardware configuration. This would be delivered to the technician in a window displayed together with a window displaying the operator's computer screen.

In an alternative preferred embodiment, the system described above is used to provide periodic service checks to ensure that all systems are optimized and running at acceptable levels of performance. For example, in the event a rechargeable battery is chronically discharging at an unexpected rate, it will be selected for repair with an E-mail message to the appropriate service technician.

The above illustrates several embodiments which would be enabled as a result of the present invention. Many modifications would be derived by those skilled in the art.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

What is claimed is:

1. A method for servicing a wireless data collection device, comprising the steps of:
providing a diagnostic program in the wireless data collection device for diagnosing the operation of the device;
receiving a request to service the device remotely initiating the diagnostic program using a communications protocol over a network;
communicating outputs from the diagnostic program using the communications protocol to the network; and
providing servicing information to a user of the device based upon the outputs from the diagnostic program.

2. The method according to claim 1, wherein the network is the Internet.

3. The method according to claim 1, wherein the information is provided over the network.

4. The method according to claim 1, wherein the request to service is received over the network.

5. The method according to claim 1, wherein the device is a scanning terminal.

6. The method according to claim 2, wherein the device is an integrated scanning terminal.

7. A method for reconfiguring a wireless data collection device, comprising the steps of:
providing a diagnostic program in the wireless data collection device for diagnosing the operation of the device;
receiving a request to reconfigure the device remotely initiating the diagnostic program using a communications protocol over a network;
communicating outputs from the diagnostic program using the communications protocol to the network; and
providing reconfiguring information to a user of the device based upon the outputs from the diagnostic program.

8. The method according to claim 7, wherein the network is the Internet.

9. The method according to claim 7, wherein the information is provided over the network.

10. The method according to claim 7, wherein the request to reconfigure is received over the network.

11. The method according to claim 7, wherein the device is a scanning terminal.

12. The method according to claim 11, wherein the device is an integrated scanning terminal.

13. A method for updating a wireless data collection device, comprising the steps of:
providing a diagnostic program in the wireless data collection device for diagnosing the operation of the device;
receiving a request to update the device remotely initiating the diagnostic program using a communications protocol over a network;
communicating outputs from the diagnostic program using the communications protocol to the network; and
providing updating information to a user of the device based upon the outputs from the diagnostic program.

14. The method according to claim 13, wherein the network is the Internet.

15. The method according to claim 13, wherein the information is provided over the network.

16. The method according to claim 13, wherein the request to update is received over the network.

17. The method according to claim 13, wherein the device is a scanning terminal.

18. The method according to claim 14, wherein the device is an integrated scanning terminal.
